(19) United States
(12) Patent Application Publication
(10) Pub. No.: US 2003/0143417 A1
(43) Pub. Date: Jul. 31, 2003

(54) Composition for producing biological degradable shaped bodies and method for producing such a composition

(76) Inventors: Anneliese Kesselring, Markt Taschendorf (DE); Thomas Koblitz, Dietersheim (DE)

Correspondence Address: Marshall Gerstein & Borun, 6300 Sears Tower, 233 South Wacker Drive, Chicago, IL, 60606-6357, US

(21) Appl. No.: 10/169,986

(22) PCT Filed: Jan. 11, 2001
(86) PCT No.: PCT/EP01/00313

(51) Int. Cl. B32B 23/04

(52) U.S. Cl. 428/533; 428/532

(57) ABSTRACT

The invention relates to a dry mixture, which comprises starch, biologically degradable fiber material, protein and, optionally, additives, for producing biologically degradable shaped bodies, and to a method for producing such a dry mixture. The invention additionally relates to a paste that can be baked, whereby this paste comprises starch, biologically degradable fiber material protein, water and, optionally, additives. Finally, the invention relates to shaped bodies that are produced by using said dry mixture or said paste that is capable of being baked.

The invention provides a dry mixture and a bakable material for producing biodegradable moulded items and a process for producing such a dry mixture or bakable material. The invention also provides the moulded items produced from this dry mixture.

Packaging materials accumulate in large amounts in industry, in trade and in the home environment. In fast-food chains, for example, large quantities of foods such as for example hamburgers, chips, sausages etc., and also hot and cold drinks are sold in plastics packaging such as, for example packaging based on polyethylene, polypropylene, polystyrene, etc. Furthermore, packaging based on plastics is also widely used in the trading sector. Thus, for example, fruit is offered for sale in pre-set amounts in plastic trays. Furthermore, for example, apples or peaches are also transported and sold in trays with hemispherical indentations. One apple or one peach is placed in each hemispherical indentation. These trays are increasingly produced from a plastics material.

The containers mentioned above, made of plastics and in the shape of beakers, plates, cups, pots, boxes and trays of all kinds have the advantage that they have a low weight. A low weight for these containers is an advantage with regard to the transport costs involved, both when transporting the empty containers themselves and also when transporting the goods stored in these containers such as, for example, fruit.

Containers made from plastics are generally disposed of as waste after being used once. As a result of the many different uses and due to the large numbers in which these containers are used on a regular basis, these containers lead to a considerable amount of waste material. The worst disadvantage is that these containers made from plastics have extraordinarily long durability. Currently, there are substantially two processes available for disposing of these plastics containers.

In the first process, plastics containers contained in any waste material are incinerated in a refuse incinerator. This procedure is disadvantageous. On the one hand, the production of plastics containers is based on the consumption of petroleum oil, i.e. a non-renewable source of raw materials. Furthermore, this procedure requires the construction of more refuse incinerators or the more intense use of refuse incinerators that are already available. However, as a result of increased public environmental awareness, the construction of new refuse incinerators would barely be tolerated at present. To this extent, there are increasing difficulties in disposal with regard to the constantly increasing quantities of waste material being produced.

In the second process, the plastics containers are taken to further processing as the starting material for freshly produced plastics containers. However, this procedure requires firstly the production of single types of plastics containers and then, after use of the plastics containers, costly separation of the containers, depending on the particular type of plastics used. Furthermore, since plastics containers are used in particular in fast-food chains, the containers have to be cleansed of food residues, fat, ketchup, etc. after use. However, such a procedure is complicated and cost-intensive so the used containers are normally incinerated in a refuse incinerator in accordance with the previously specified process.

With regard to the disadvantages associated with plastics containers, attempts have been made for some considerable time to produce biodegradable containers which can be used as plates, cups, holders, trays, etc. for the uses mentioned above.

The prior art discloses moulded items based on starch which are partly or fully biodegradable.

PCT/EP95/00285 (WO 96/23026) discloses a process for producing moulded items in which a viscous material consisting of biodegradable fibrous material, water and starch is baked in a baking tin with the production of a fibrous material/starch composite. In this case, waste paper, recycling material or biodegradable fibrous material which has previously been pulled apart by shredding is used as the fibrous material. The proportion of starch to water in the viscous material is preferably 1:3 to 1:2. The baking time can be varied between 0.5 and 15 minutes, wherein it is stated that short cycle times in the range of 1 to 3 minutes are generally sufficient. However, if the proportion of water in the baking material is raised, a baking time between 4 and 12 minutes is required in order to obtain good results.

The disadvantage is that, in order to produce shorter baking times, the water content in the baking material has to be reduced so that ultimately larger amounts of starch and fibres are used per moulded item produced.

For economic reasons, mass-produced products, as is the case with the moulded items in question here, for example for use in fast-food restaurants, have to be capable of production at a low price. In this regard, short production times and a low consumption of material are of critical importance to a manufacturer in order to be able to promote his products successfully on the market.

U.S. Pat. No. 5,607,983 discloses a process for producing a biodegradable moulded item. Short plant fibres, plant fibre powder, gelling material, water, propellant and auxiliary substances are stirred to produce a dough and then heated at a temperature of 150° C. to 200° C. for 2 to 3 minutes and then dried for 20 minutes at a temperature of 120° C.

The disadvantages are that, on the one hand this process requires the use of a propellant and on the other hand the production time is very long. Neither the additional use of a propellant nor the production time of altogether 22 to 23 minutes per moulded item can lead to economically viable production of such moulded items as mass-produced articles.

WO 95/04104 discloses a process for producing a substantially biodegradable polymer foam, wherein thermoplastic or destructured starch, a biodegradable hydrophobic polymer and a biodegradable fibrous or capsule-like material which has the ability to bind water in capillaries, are mixed. This process is costly because, in a first step, firstly thermoplastic starch has to be mixed with fibres which have been saturated with water, within a precisely defined temperature and pressure range wherein it is essential that the water bonded in capillaries in the fibres is not released. Foam production then takes place in a second step, in which both the temperature and the pressure are increased so that the water bonded in capillaries in the fibres is released in order to expand the starch. This process requires a costly process management system with regard to the precise temperature and pressure range which has to be maintained.

DE 40 09 408 A1 discloses that a dough can be produced from cellulose-containing and protein-containing materials and water, which can subsequently be shaped and then baked in order to provide a degradable, disposable item. The disposable item produced by this process consists of a protein lattice in which the cellulose is embedded.

The disadvantage is that the disposable item produced in this way has to have a wall thickness of about 0.5 cm, for stability reasons. The production of thin-walled moulded items, e.g. in the shape of cups, beakers, pots, bowls, etc., in an acceptable quality, is not possible. Furthermore, for the stability reasons given above, it is not possible to provide light-weight trays for fruit such as e.g. apples, peaches, etc. using this process.

Furthermore, as a result of the thick walls, elevated use of materials is required. Also, these thick walls require long baking times of about three to ten minutes and a high baking temperature of about 250° C. Thus, using the process disclosed in DE 40 09 408 A1, high-quality moulded items cannot be produced. Furthermore, this process is unsuitable for producing low-price, high-quality mass-produced items due to the high materials input.

EP 0 683 831 B1 discloses a process for dispersing cellulose-containing fibres in water. This process enables the use of cellulose-containing fibres which are bonded together, such as are present, for example, in paper materials. With a solids content of up to 80%, hydrocolloids such as e.g. starch, plant or animal protein, are added to an aqueous dispersion of cellulose-containing fibres under the effects of a strong mechanical force in order to provide a highly viscous material in which the cellulose-containing fibres separate and become distributed in the viscous material. It is necessary to use enough hydrocolloid for all the water to be bonded. Corn flour is normally used as the hydrocolloid.

The disadvantage is that a high consumption of material is associated with the production of a moulded item from the highly viscous material prepared using this process, due to the high solids content. Thus, the use of this highly viscous material does not enable the low-cost production of moulded items, which is a severe disadvantage in particular when producing mass-produced items. Furthermore, the moulded items produced from this viscous material have a high weight, which ultimately leads to increased transport costs for the moulded items produced.

The object of the present invention is to provide a composition for producing a biodegradable moulded item which enables the reliable and low-cost production of high quality biodegradable moulded items. In particular there is a need for a composition which facilitates a reduction in the production time and a reduction in the amount of material used. Furthermore there is a requirement for a process for producing such a composition.

The object of the present invention is achieved by a dry mixture which contains starch, biodegradable fibrous material and protein and optionally additives for producing biodegradable moulded items.

The expression “dry mixture” in the context of the invention is understood to be a free-flowing composition in the form, for example, of a powder or granules. It is not necessary that the dry mixture according to the invention is absolutely dry. The dry mixture may contain a residual moisture content of, for example, about 5 to about 14 wt. %, preferably less than 9 wt. %.

In the context of the invention, the expression “starch” is understood to include natural starch, chemically and/or physically modified starch, industrially produced or genetically modified starch and mixtures thereof. Cereal starches such as, for example, those obtained from maize, waxy maize, wheat, barley, rye, oats, millet, rice, etc. or cassava or sorghum can be used as starch. Obviously, the starch present in leguminosae such as beans or peas or the starch present in fruit such as, for example, chestnuts, acorns or bananas can also be used. Furthermore, the starch present in roots or tubers can be used.

Particularly suitable for the present invention is potato starch. Potato starch advantageously contains one phosphorus ester group per 200 to 400 anhydroglucose units. The negatively charged phosphate groups are linked to the C6 position in the anhydroglucose unit. When producing a bakable material from the dry mixture according to the invention, the negatively charged phosphate groups cause unravelling of the individual potato amylopectin molecules via mutual repulsion. Due to mutual repulsion by the negatively charged phosphate groups, the bends in the amylopectin molecule are largely unfolded or stretched out.

This presence of esterified phosphate groups produces a high viscosity in potato starch/water mixtures.

The expression “biodegradable fibrous material” is understood to include in particular plant and animal fibres. Plant fibres used in the context of the invention are preferably cellulose-containing fibres. Cellulose-containing fibres are those fibres of any type which contain cellulose or consist of cellulose. Animal fibres are understood to be so-called protein fibres such as, for example, wool, hair or silk.

Particularly preferably, plant fibres are used which can be present with different lengths and widths. In particular, plant fibres are used which have a length in the range about 50 μm to about 3000 μm, preferably about 100 μm to about 2000 μm, more preferably about 150 μm to about 1500 μm, still more preferably about 200 μm to about 900 μm, most preferably 300 μm to about 600 μm. The width of the plant fibres can lie in a range from about 5 μm to about 100 μm, preferably about 10 μm to about 60 μm, particularly preferably about 15 μm to about 45 μm. The fibres are mainly produced from wood, hemp or cotton. Such fibres can be produced in a known manner by a person skilled in the art.

The expression “protein” is understood to include biopolymers based on amino acids. Suitable amino acids are all the so-called proteinogenic amino acids, i.e. the amino acids which normally contribute to building up proteins, and also so-called non-proteinogenic amino acids which do not generally contribute to the structure of proteins.

The expression “protein”, according to the invention, also includes peptides or polypeptides. Furthermore, in the context of the invention, the expression “protein” includes naturally occurring protein, chemically modified protein, enzymatically modified protein, recombinant protein, protein hydrolysates or mixtures thereof. The protein may be of plant or animal origin.

Surprisingly, the dry mixture according to the invention, which contains starch, biodegradable fibrous material and protein, facilitates a shortening in baking time of up to 35%, preferably up to 50%. Furthermore, the use of protein in the dry mixture according to the invention facilitates a reduction of up to 10 wt. % to 20 wt. % in the materials requirement when producing moulded items.

The dry mixture according to the invention can be stored, extremely advantageously, for a long period of time without any marked change in the composition. Advantageously, this enables pre-preparation and storage of the dry mixture. To this extent, it is possible, for example, to provide subcontractors of a manufacturer of biodegradable moulded items with the dry mixture according to the invention and thus ensure that the moulded items produced at the subcontractor's have the desired quality. Since water or gelatinised starch has to be added to the dry mixture according to the invention only at the subcontractor's, transport costs for the dry mixture only are involved, i.e. the water being added does not have to be transported.

In order to produce biodegradable moulded items, the dry mixture according to the invention is first blended, with the addition of water, to give a bakable material or a dough. The bakable material produced from the dry mixture according to the invention differs from the baking materials known from the prior art in that it is more creamy, foamy and voluminous and thus has a lower density. Thus, in order to produce a specific volume of bakable material, use of the dry mixture according to the invention requires less material than when using a dry mixture which does not contain protein.

To produce a biodegradable moulded item, a specific volume of bakable material (baking material, dough) is placed in a baking tin. These baking tins are known from the waffle-baking industry. Since a specific volume of bakable material is placed in each of these baking tins, the increased volume of the bakable material based on the dry mixture according to the invention thus leads to a reduction in materials requirement. Since moulded items produced using the dry mixture according to the invention are produced in very large numbers, a reduction in materials requirement of up to 10 wt. % to 20 wt. % represents an enormous saving in costs.

Furthermore, the use of a bakable material based on the dry mixture according to the invention leads to a reduction in the baking time required to produce a moulded item.

“Baking time” in the context of the invention is understood to be the time between closing the baking tin, which occurs after filling the baking tin with bakable material, and opening the baking tin to remove the baked moulded item.

The baking time is shortened by up to 50% when using a bakable material based on the dry mixture according to the invention. The reason for the reduction in baking time is not clear. The inventor suspects the following:

Due to the larger volume of a bakable material produced on the basis of the dry mixture according to the invention, a smaller portion by weight of bakable material is placed in the baking tin. The smaller portion by weight of bakable material naturally also contains less water which has to be evaporated during the baking process. It is therefore assumed that there is a connection between the reduction in the amount of bakable material being baked and the shorter baking time.

In addition, the inventor has shown that a moulded item produced with the dry mixture according to the invention has large and uniform pores or capillary structures within the interior of the baked moulded item, i.e. in the interior of the walls of the moulded item, that is for example in the base, lid and side regions. These large pores or capillaries facilitate the easier escape of water/water vapour than in moulded items which have been produced using a dry mixture without protein. Therefore, it is assumed that there is a connection between the large pores and capillaries and the shorter baking time.

Furthermore, with regard to the large and uniform pore structure within the walls of conventional moulded items, there is a weight reduction of up to 20% in the moulded items produced. A weight reduction of up to 20% is extremely advantageous when transporting the moulded items.

Furthermore, moulded items produced using the dry mixture according to the invention have a closed surface. A closed surface is of particular advantage with regard to the thermal insulation properties of the moulded item. Furthermore, a closed surface brings about better and more reliable repulsion of for example moisture or fat at the walls or base of the moulded item.

In accordance with a preferred embodiment, starch, biodegradable fibrous material and/or protein are fixed to each other in the dry mixture according to the invention.

In the context of the invention, the expression “fixed to each other” is understood to mean that the components in the dry mixture according to the invention, i.e. starch, biodegradable fibrous material, protein and optionally added additives, adhere to each other with and without the use of a bonding agent.

Thus, for example, starch and biodegradable fibrous material can be fixed to each other. Starch and protein or biodegradable fibrous material and protein can also be fixed to each other. Starch, biodegradable material and protein are preferably fixed to each other. Furthermore, it is possible that the added additives are also fixed within any of the previously mentioned possibilities. In other words, according to the invention, all possible fixing combinations between the components used are possible.

Demixing of the dry mixture according to the invention is extremely advantageously prevented in this way. For this purpose, it may be sufficient that only starch and the biodegradable fibrous material are fixed to each other. Such demixing can occur, for example, during transport using heavy goods vehicles or the railway due to regularly occurring vibrations if, for example, the biodegradable fibrous material and the starch are not fixed to each other. The risk of demixing depends strongly on the particular size of particles and/or fibres used.

Further explanations with regard to performing the fixing procedure are given in the details for the process for producing the dry mixture according to the invention.

The dry mixture according to the invention is preferably present as granules.

The expression “granules” is understood to be an accumulation of granular grains. A granular grain (pellet) is an asymmetric aggregate of powder particles. It does not have a harmonic, geometric shape. The shape of a sphere, a rod, a cylinder, etc. is produced only approximately and by suggestion. The surface is generally uneven and jagged, in many cases the material is fairly porous. The so-called fluidised bed process is often used to produced granules.

Provision of the dry mixture according to the invention as granules advantageously enables simple packing and handling of the dry mixture according to the invention. In particular a dry mixture according to the invention, when present as granules, is very easy to meter out, which is extremely advantageous when automating a process for producing biodegradable moulded items.

The starch present in the dry mixture according to the invention is preferably native starch. Native starch is obtained in granular form by the wet milling of starch-containing raw materials such as e.g. cereals, tubers and roots. Since the starch is then already present as granules, production of the dry mixture according to the invention as granules is very simple.

According to a preferred embodiment, the protein is chosen from the group which consists of naturally occurring protein, chemically modified protein, enzymatically modified protein, recombinant protein, protein hydrolysates and mixtures thereof.

Preferably, about 0.5 to about 12 wt. %, particularly preferably about 2 to about 10 wt. % and most preferably about 4 to about 8 wt. % of protein is present in the dry mixture according to the invention.

However, the amount of protein present in the dry mixture according to the invention can vary with the protein used or the protein mixture used. Furthermore, however, it is also possible to determine an optimum amount for each dry mixture of the particular protein being added by means of a few trials within the ranges stated above.

Examples of proteins which may be used are proteins of animal origin such as, for example, actin, myoglobin, myosin, haemoglobin, collagen, elastin, immunoglobulins, keratins, fibroin, conchagene, ossein, albumins, casein, FPC (fish protein concentrate).

Proteins of plant origin which may be used are prolamines such a e.g. gliadin, secalin, hordein, zein and maize and soya protein.

Plant proteins such as e.g. soya, maize, pea, lupin, millet protein, have proven to be very suitable for the purposes of the invention. Soya protein is particularly preferably used. Soya protein is extremely advantageously available in large amounts at low prices.

In accordance with a further development of the invention, hydrophobic proteins are used as proteins. Hydrophobic proteins are characterised by a high proportion of uncharged amino acids in the amino acid sequence. In particular, these proteins contain high proportions of glycine, alanine, valine, leucine, isoleucine, phenylalanine, tryptophan, proline and methionine, wherein these provide the protein overall with a hydrophobic character.

It is obvious to a person skilled in the art that the proteins listed above represent only an example of the selection in order to illustrate the invention. Obviously, other proteins or protein mixtures can also be used. The essential criterion is that, with regard to the very large numbers of moulded items being produced, the price of the protein or protein mixture being used is low.

In accordance with a preferred embodiment of the present invention, the protein is chosen from the group which consists of casein, alkali metal caseinate, alkaline earth metal caseinate, casein hydrolysate and mixtures thereof.

Extremely advantageously, casein and caseinates are available in large amounts at an acceptable price. With regard to the large numbers of biodegradable moulded items being produced from the dry mixture according to the invention, it is essential that the protein used in the dry mixture according to the invention has a low price. Thus, about 1 kg of casein can be obtained from 30 l of skimmed milk.

The casein is used in the form normally isolated from milk. Naturally, it is also possible to use the α-, β- and γ- sub-units of casein separately or in specific combinations thereof.

In the context of the invention, casein is obtainable commercially as acid casein from BMI-Landshut.

Preferably, about 1 to about 10 wt. %, particularly preferably about 2 to 8 wt. % and most preferably about 3 to about 7 wt. % of casein is present in the dry mixture according to the invention.

Plant protein is also preferably present in the dry mixture according to the invention, preferably soya protein in an amount of about 0.5 to about 10 wt. %.

The casein can be used as such or as an alkali metal caseinate or alkaline earth metal caseinate. Calcium caseinate has proven to be especially useful.

Calcium caseinate which can be used in the context of the invention is available commercially as Caseinato Di Calcio from BMI-Landshut.

Preferably about 1 to about 10 wt. %, particularly preferably about 2 to about 8 wt. % and most preferably about 3 to about 7 wt. % of calcium caseinate is present in the dry mixture according to the invention.

In accordance with another preferred embodiment of the invention, the dry mixture according to the invention may contain further additives. Using these additives, it is possible to have an effect on the properties of the biodegradable moulded items produced from the dry mixture according to the invention. Examples of additives which may be present in the dry mixture are hydrophobising agents, whitening agents, foodstuffs colorants, flavourings, etc.

It has proven especially beneficial to introduce an additive or several additives adhering to the starch in order to have an effect on the product properties of the moulded item. Application of the additive as adhering to starch advantageously prevents possible demixing of the additive and starch during transport of the dry mixture according to the invention. The dry mixture according to the invention preferably contains up to 10 wt. %, preferably 0.3 to 5 wt. %, particularly preferably 0.9 to 1.8 wt. % of additive.

The expression “additive” in the context of the invention includes any compounds which are suitable for affecting the product properties of the moulded item. These additives are preferably fully or substantially fully biodegradable. Preferred examples of these additives are hydrophobising agents, whitening agents, colorants, foodstuffs colorants, flavourings, etc.

Hydrophobising agents are constituents which provide the moulded item produced from the dry mixture according to the invention with hydrophobic properties. Whitening agents are compounds which are used to lighten the colour of the moulded item. Examples of colorants which are used are blue colorants which are used, for example, for colouring fruit boxes or fruit trays. The following blue colorants may be used, for example: natural colorants or lacquer colorants. Green colorants, for example, may also be used for colouring pots for holding plants. The following green colorants may be used, for example: natural colorants or lacquer colorants.

Foodstuffs colorants are colorants used for the design of coloured packaging for foodstuffs. Flavourings in the context of the invention are any, in particular biodegradable, flavourings which provide, for example, the moulded item produced from the dry mixture according to the invention with a certain odour and/or taste.

A particularly preferred example of a hydrophobising agent is fluoroalkyl polymers, wherein the expression “fluoroalkyl polymers” indicates that they are polymers which are built up in particular from repeating alkyl units, wherein one or more, optionally even all, of the hydrogen atoms can be replaced by fluorine atoms. For example, a hydrophobising agent based on a perfluoroalkyl acrylate copolymer can be used.

The whitening agent can be a compound with at least one disulfone group. Such compounds are well known to a person skilled in the art and engaged in this industrial field. An example of such a disulfone compound is 4,4′-bis-(1,3,5-triazinylamino)-stilbene-2,2′-disulfonic acid.

Furthermore, the object underlying the invention is achieved by a bakable material which contains starch, biodegradable fibrous material, protein and water and optionally additives.

The expression “bakable material” is understood to be a baking material or dough which can be baked in baking devices known from waffle technology such as e.g. baking tongs with the formation of a moulded item. The bakable material is placed, for example, in a heated baking tin for such a baking device, wherein the bakable material is distributed in the baking tin and this is filled completely. The bakable material present in the baking tin emits water or water vapour when subjected to heat and this emerges from the baking tin through the escape channels provided. During this process, solidification of the bakable material takes place with the production of the desired moulded item.

The bakable material can be prepared from the dry mixture according to the invention by adding water and optionally additives, if these are not already present in the dry mixture, by blending such as, for example, by stirring or kneading.

The bakable material preferably contains about 3 wt. % to about 15 wt. %, preferably about 5 wt. % to about 10 wt. %, most preferably 7.8 wt. % to about 9.8 wt. % of biodegradable fibrous material, preferably cellulose-containing fibres.

Furthermore, the bakable material preferably contains about 6 wt. % to about 30 wt. %, preferably about 10 wt. % to about 20 wt. %, most preferably about 16.1 wt. % to about 20.05 wt. % of native starch.

Furthermore, the bakable material preferably contains about 2 wt. % to about 10 wt. %, preferably about 4 wt. % to about 8 wt. %, most preferably about 5.4 wt. % to about 6.8 wt. % of pregelatinised starch.

Furthermore, the bakable material preferably contains about 45 wt. % to about 90 wt. %, preferably about 60 wt. % to about 80 wt. %, more preferably about 60 wt. % to about 75 wt. %, most preferably about 63 wt. % to about 71 wt. % of water.

Protein is present in the bakable material according to the invention in an amount of up to 10 wt. %, preferably up to about 5 wt. %, more preferably up to about 3 wt. % protein, most preferably up to about 2 wt. %.

The bakable material preferably contains 0.5 to 10 wt. % of plant protein. Plant proteins such as e.g. soya, maize, peas, lupins, millet protein have proven to be particularly suitable for the purposes of the invention. Soya protein is particularly preferably used. Soya protein is extremely advantageously available in large amounts at a low price. More preferably, the bakable material preferably contains 1 to 2 wt. % of plant protein, preferably soya protein.

The preceding data given as percentages by weight are each given with respect to the total weight of the bakable material.

Pregelatinised starch can be produced from about 90 to about 99.9 wt. % water and about 0.1 to about 10 wt. % of native starch, more preferably from about 95 wt. % water and about 5 wt. % native starch. A starch suspension is first produced from these two components. This starch suspension can then be heated and subsequently cooled in order to produce pregelatinised starch.

Heating preferably takes place at a temperature at which the aqueous suspension of starch granules turns into a sticky form. This temperature is also known as the Kofler gelatinisation temperature. The Kofler gelatinisation temperature for potato starch is between 56 and 66° C. and for maize starch is between 62 and 72° C. The suspension is held within this temperature range, for example, for a period of about 10 minutes. Then the pregelatinised starch is cooled.

The temperature to which it is cooled is preferably about 50° C. or lower.

The description given above for producing pregelatinised starch is understood to be simply an example of a method of production. Obviously other processes for producing pregelatinised starch are known to a person skilled in the art and these may be used for the present invention. For example, the starch suspension or slurry can also be gelatinised with steam in a so-called jet-cooker.

According to an advantageous further development, the biodegradable fibrous material consists of cellulose-containing fibres. Furthermore, it is preferable that the starch is native starch. Moreover, the bakable material preferably contains protein which is chosen from the group which consists of naturally occurring protein, chemically modified protein, enzymatically modified protein, recombinant protein, protein hydrolysates and mixtures thereof. The protein is preferably chosen from the group which consists of casein, alkali metal caseinate, alkaline earth metal caseinate, casein hydrolysate and mixtures thereof. The alkaline earth metal caseinate calcium caseinate is particularly preferred.

For further details, appropriate reference is made to the particular specifications for the dry mixture according to the invention.

The bakable material according to the invention can obviously also be produced without using the dry mixture according to the invention. The relevant individual components, i.e. starch, biodegradable fibrous material, protein and optionally additives can be mixed in any sequence with water to produce the bakable material according to the invention. For example, a dough can first be produced from starch, biodegradable fibrous material and water, to which are then added protein and optionally additives.

The object underlying the invention is also achieved by using protein to produce a dry mixture or a bakable material in order to produce biodegradable moulded items. Furthermore, the object is achieved by a moulded item which has been produced using the dry mixture according to the invention or the bakable material according to the invention.

The dry mixture according to the invention is outstandingly suitable for producing biodegradable moulded items.

Water is added to the dry mixture according to the invention, which contains starch, biodegradable fibrous material and protein and optionally other additives, and mixed until a bakable material is obtained.

A bakable material is preferably characterised by a homogeneous distribution of all the constituents and has a viscosity which is required for the particular purpose. The viscosity of the bakable material can be adjusted by the proportion of water added to the dry mixture consisting of starch, biodegradable fibrous material and protein and optionally additives. The preferred viscosity of the baking material required for the particular moulded item being produced can be determined using a few trials. It may be advantageous to adjust the viscosity of the baking mixture, depending on the shape, the size and the particular wall thickness of the moulded item being produced and on the size of the particular baking tin being used to bake the moulded item.

The bakable material produced is then baked. For this purpose, the bakable material is placed in a baking tin and heated in a closed baking tin at a temperature of preferably about 100° C. to about 200° C., particularly preferably at about 150° C.

The baking tin is designed as a function of the shape of the desired end product, for example in the shape of a pot or a beaker. The baking tin can be formed from at least two baking sheets, i.e. an upper and a lower baking sheet, which are held in baking tongs, wherein the inner surfaces of the baking sheets are held at a distance when the baking tin is in a closed, locked condition, with the formation of a mould cavity. The mould cavity is then filled with the bakable material. The baking tin has specially designed evaporation openings for the escape of water vapour. A plurality of baking tongs may also be used for the simultaneous production of a plurality of moulded items. Such devices for baking are based on the technology for waffle baking which is known per se.

The duration of the baking process is substantially determined by the size of the moulded item being baked and also by the particular wall thickness chosen for the moulded item. The baking time is normally between 10 s and about 100 s, preferably about 30 s to about 80 s, more preferably 60 s to 70 s.

The object of the invention is also achieved by a process for producing the dry mixture according to the invention (first embodiment), wherein

a) starch, biodegradable fibrous material and protein are mixed;

b) an aqueous solution is sprayed on during mixing; and

c) the mixture obtained in accordance with step b) is dried.

Furthermore, the object of the invention is achieved by a process for producing the dry mixture according to the invention (second embodiment), wherein

a) starch and biodegradable fibrous material are mixed;

b) an aqueous protein-containing solution is sprayed on during mixing; and

c) the mixture obtained in accordance with step b) is dried.

The expression “aqueous solution” is understood according to the invention to be water or a solution based on water such as, for example, a protein-containing aqueous solution, pregelatinised starch, protein-containing pregelatinised starch, an additive-containing aqueous solution, etc.

In this process, additional pregelatinised starch is preferably sprayed on in step b) during mixing.

The fixing of, for example, starch and biodegradable fibrous material to each other can be achieved by, for example, spraying water on during mixing of the starch, biodegradable fibrous material and protein and drying the mixture. The water preferably evaporates shortly after it has come into contact with the starch, biodegradable fibrous material and protein; i.e. the water is added in an amount and over a sufficient time for the surface of the starch particles or grains to be made slightly tacky. The biodegradable fibrous material, for example cellulose fibres, and the protein then remain adhering to the surface of these starch particles which have been “made tacky”. Naturally, it is also possible for the protein to act as a kind of adhesive as soon as it comes into contact with water and fix the starch and biodegradable fibrous material to each other. Naturally, the two effects may also occur at the same time.

According to the second embodiment, an aqueous protein-containing solution is sprayed on instead of water during the mixing of starch and biodegradable fibrous material. Fixing of the starch, biodegradable fibrous material and protein to each other is also achieved in this second process. Fixing the components to each other is performed using the same effects as described for the first embodiment.

On the one hand a sticking together of starch particles and biodegradable fibrous materials is achieved by spraying on an aqueous protein-containing solution. Moreover, the spraying on of an aqueous protein-containing solution means that the starch particles and the biodegradable fibrous material become coated with the protein-containing solution and thus the starch particles and biodegradable fibrous material act as support materials for the protein.

Furthermore, pregelatinised starch as an aqueous solution can also be sprayed on instead of water and thus achieve fixing of the starch, biodegradable fibrous material and protein. The pregelatinised starch preferably has a temperature of less than 50° C. Obviously both water and pregelatinised starch may be sprayed on in sequence or at the same time.

In the second embodiment of the process according to the invention, it is possible to spray on an aqueous protein-containing solution and pregelatinised starch in sequence or at the same time. Furthermore, it is also possible to introduce the protein directly into the pregelatinised starch and then spray on the protein-containing, pregelatinised starch during mixing of the biodegradable fibrous material and starch.

Drying the mixture to produce the dry mixture according to the invention can take place, for example, in a warm environment such as e.g. a warm stream of air. However, other drying techniques which have long been familiar to a person skilled in the art may also be used.

Mixing during the process according to the invention (embodiment 1 or 2) in accordance with step b) and drying in accordance with step c) are preferably performed in a single step by fluidising in a fluidised bed in a warm stream of air.

Particularly preferably, the spraying on of aqueous or aqueous protein-containing solution and optionally of pregelatinised starch is performed in a fluidised bed unit in which starch and biodegradable fibrous material are fluidised in a warm stream of air. Here again, the pregelatinised starch can be sprayed in before or after or at the same time as the aqueous or aqueous protein-containing solution. Obviously, a previously prepared, optionally protein-containing pregelatinised starch can also be sprayed into the fluidised bed here. The solutions are preferably sprayed on using spray nozzles located above the fluidised bed.

The use of a fluidised bed reactor in which the starch, biodegradable fibrous material and optionally protein are fluidised in a warm stream of air is especially advantageous when the dry mixture according to the invention is intended to be provided as dry granules. Within the fluidised bed produced by the warm stream of air, the water introduced with the aqueous or aqueous protein-containing solution and the optionally sprayed on pregelatinised starch evaporates very rapidly. Fixing of the biodegradable fibrous material, starch particles and protein to each other takes place in the fluidised bed as the water evaporates. Thus, extremely advantageously, a dry mixture according to the invention is produced in which demixing of starch, biodegradable fibrous material and protein cannot occur.

The temperature of the warm steam of air in the fluidised bed unit is preferably about 40° C. to about 90° C., preferably about 50° C. to about 70° C. As mentioned above, the aqueous or aqueous protein-containing solution and optionally pregelatinised starch can be sprayed on via spray nozzles located above the fluidised bed.

Furthermore, the additives mentioned above can be sprayed on in the form of aqueous solutions. The additives can be made up appropriately, depending on the properties of the moulded item being produced, and sprayed on at the same time as or in sequence with the aqueous or aqueous protein-containing solution and optionally the pregelatinised starch.

Furthermore, it is possible to spray on a fat-containing mould release agent with the pregelatinised starch sprayed on at a temperature of about 50° C. The fat-containing mould release agent may consist, for example, largely of fat and also contain at least one component which is chosen from the group consisting of oil, wax and lecithin. Beeswax is preferably used as a wax.

Obviously, commercially available fat-containing mould release agents such as, for example, Premix, may also be used. Premix is a mixture of fully or partly unhardened plant fats and can be obtained from I.C.L. van der Zon in Essen under the reference number HC 2000.

In general, plant fats and oils have proven suitable as mould release agents. However, synthetic fats and oils may also be used. The mould release agent is preferably chosen from the group consisting of soya bean oil, palm fat and mixtures thereof. The concentration of mould release agent is preferably 0.05 to 0.7 wt. %, more preferably 0.1 to 0.2 wt. %, each with respect to the bakable material. These mould release agents can be sprayed on together with the pregelatinised starch and/or protein-containing solution, for example as a soya protein solution.

However, the fat-containing mould release agent may also be added in a separate working step to the bakable material itself or during preparation of the bakable material from the dry mixture according to the invention. Obviously, however, it is also possible to place the fat-containing mould release agent directly in the baking tin immediately before the baking process.

The following examples are used to further illustrate the invention.

To produce a bakable material, native starch and cellulose fibres were placed in a fluidised bed unit on a Conidur base with an area of 1862 cm² (26.6 cm×70.0 cm). The depth of the bed was a total of about 225 mm. Potato starch (as a powder) with a moisture content of about 16 wt. % was used as native starch. Cellulose fibres with a length of about 600 μm and a width of about 30 μm were used as biodegradable fibrous material.

The native potato starch and cellulose fibres were mixed dry in a fluidised bed. Warm air with a temperature of about 70° C. and a volume flow of 480 m³/h was passed through the starch/cellulose fibre mixture, from below the base, in order to produce a fluidised bed.

Pregelatinised starch was sprayed on from above the fluidised bed at a spray rate of 65 g/min for 5 minutes, via two nozzles, each with a nozzle diameter of 0.8 mm and a spray pressure of 1.2 bar. The temperature of the sprayed on solution of pregelatinised starch was less than 50° C.

The product obtained consisted of granules in which starch and cellulose fibres were uniformly bonded together. (The product temperature was 42° C. and the product moisture content was 8.6 wt. %).

The granules obtained in this way were mixed with water in order to adjust to the following concentration ranges:

| | |
|---|---|
| Cellulose fibres | 9.72 wt. %-7.84 wt. % |
| Potato starch | 20.05 wt. %-16.17 wt. % |
| Pregelatinised starch | 6.79 wt. %-5.48 wt. % |
| Water | 63.43 wt. %-70.51 wt. % |

The bakable material mentioned above was portioned out and the corresponding proportion of protein, i.e. casein or calcium caseinate, was added as cited below. The protein was homogeneously distributed in the bakable material, in the proportions cited below, by mixing.

To determine the reduction in baking time, moulded items were then baked in the same baking tins, wherein the bakable material or dough was used with and without the addition of protein. The baking time was determined by determining the time from closing the baking tin, after the bakable material had been placed in the baking tin, up to opening the baking tin in order to remove the baked moulded item.

The amount of casein added in wt. % is given with respect to 100 wt. % of the bakable material mentioned above. The reduction in baking time as a percentage was calculated with reference to the time by which the baking time was shortened in absolute terms as compared with the baking time for the comparison mixture without the addition of protein.

The following results were obtained:

TABLE 1
Casein added to the dough (bakable material)

| | Reduction in baking time as |
|---|---|
| Casein added in wt. % | %-age |
| 0.5% | 10% |
| 1.0% | 20% |
| 2.0% | 30% |
| >2.0% | 30% |
| up to 10% | 30% |

TABLE 2
Calcium caseinate added to the dough (bakable
material)

| | Reduction in baking time as |
|---|---|
| Calcium caseinate in wt. % | %-age |
| 0.5% | 15% |
| 1.0% | 25% |
| 2.0% | 35% |
| >2.0% | 35% |
| 10% | 35% |

The data in wt. % for added calcium caseinate and the data with respect to reduction in baking time were determined as described above.

It can be seen that a clear reduction in baking time can again be achieved by using calcium caseinate.

Since the moulded items are produced as mass-produced items, a reduction in baking time of, for example, 25% when adding 1.0 wt. % of calcium caseinate is a very significant improvement in the process with regard to the economic aspects. Furthermore, since not only is the baking time reduced to a considerable extent but also the materials requirement is reduced by 10 wt. % to 20 wt. %, the invention represents a significant advance in the field of producing biodegradable moulded items.

When using soya protein instead of casein or caseinate, comparable advantageous effects are produced. Since soya protein is cheaper than casein or caseinate, soya protein is preferably used as added protein when producing large quantities of biodegradable moulded items. The bakable material preferably contains 0.5 to 10 wt. %, more preferably 1 to 2 wt. %, of soya protein.

In addition, biodegradable moulded items produced with the addition of protein have better thermal insulation characteristics with a more uniform pore structure.

After the baking process, the biodegradable moulded items produced using this process have a residual moisture content of about 6 wt. %, which may rise to about 10 wt. % after storage of the moulded items at ambient humidity. Adjusting the residual moisture content to about 10 wt. % has proven to be advantageous with regard to the flexibility of the moulded items produced. In fact, it has been shown that a residual moisture content of about 10 wt. % makes the moulded items more flexible.

The biodegradable moulded items according to the invention produced from the dry mixture according to the invention can be produced extremely advantageously at a low cost, with a clear reduction in baking time and a reduction in the materials requirement. Furthermore, the biodegradable moulded items produced using the dry mixture according to the invention have outstanding characteristics with regard to breaking strength, elasticity, insulation properties and surface quality.

The closed surface on moulded items according to the invention also facilitates the reliable application of moisture- and grease-repellent barrier layers, for example in the form of biodegradable films. These films of polyester, polyesteramide or polylactic acid may be applied to the baked moulded item. It has been shown that the adhesive properties of the moulded items produced using the dry mixture according to the invention are improved when applying barrier layers in the form of films, for example using the thermoforming process.

When using the dry mixture according to the invention or the bakable material according to the invention, cheap, high-quality, biodegradable moulded items can be produced. For example, moulded items according to the invention have a wall thickness of about 1.6 to 1.8 mm. Obviously, moulded items with thinner walls, such as for example about 0.8 to about 1.4 mm, or thicker walls such as for example about 2.0 to about 3.2 mm can also be produced.

The moulded items are produced extremely advantageously from renewable raw materials and can biodegrade completely or substantially completely. To this extent, the dry mixture or bakable material according to the invention is not subject to the “Green Point” system created in Germany for the waste disposal of packaging. That is, a producer of the previously mentioned moulded items in the form of packaging material does not have to pay the conventional packaging duty to the “Green Point” waste disposal system.

The moulded items produced from the dry mixture or bakable material according to the invention are almost fully biodegraded, in a pit or in a compost heap, within 10 to 14 days.

1. A dry mixture which contains starch, biodegradable fibrous material and protein and optionally additives, for producing biodegradable moulded items, characterised in that starch, biodegradable fibrous material and/or protein are fixed to each other.

2. A dry mixture according to claim 1, wherein the dry mixture is present as granules.

3. A dry mixture according to one of the preceding claims, wherein the biodegradable fibrous material consists of cellulose-containing fibres.

4. A dry mixture according to one of the preceding claims, wherein the starch is native starch.

5. A dry mixture according to one of the preceding claims, wherein the protein is chosen from the group which consists of naturally occurring protein, chemically modified protein, enzymatically modified protein, recombinant protein, protein hydrolysates and mixtures thereof.

6. A dry mixture according to one of the preceding claims, wherein the protein is chosen from the group consisting of casein, alkali metal caseinate, alkaline earth metal caseinate, casein hydrolysate and mixtures thereof.

7. A dry mixture according to one of the preceding claims, wherein the alkaline earth metal caseinate is calcium caseinate.

8. A bakable material which contains starch, biodegradable fibrous material, protein and water and optionally additives and is produced from a dry mixture according to one of the preceding claims.

9. A bakable material according to claim 8, wherein the protein is present in the bakable material in an amount of up to 10 wt. %, preferably up to 5 wt. %.

10. A bakable material according to claim 8 or 9, wherein the biodegradable fibrous material consists of cellulose-containing fibres.

11. A bakable material according to one of claims 8 to 10, wherein the starch is native starch.

12. A bakable material according to one of claims 8 to 11, wherein the protein is chosen from the group which consists of naturally occurring protein, chemically modified protein, enzymatically modified protein, recombinant protein, protein hydrolysates and mixtures thereof.

13. A bakable material according to one of claims 8 to 12, wherein the protein is chosen from the group which consists of casein, alkali metal caseinate, alkaline earth metal caseinate, casein hydrolysate and mixtures thereof.

14. A bakable material according to one of claims 8 to 13, wherein the alkaline earth metal caseinate is calcium caseinate.

15. The use of protein to produce a dry mixture according to one of claims 1 to 8 or a bakable material according to one of claims 8 to 14.

16. The use of a dry mixture according to one of claims 1 to 7 or a bakable material according to one of claims 8 to 14 to produce moulded items.

17. A moulded item, characterised in that the moulded item is produced using a dry mixture according to one of claims 1 to 7 or a bakable material according to one of claims 8 to 14.

18. A process for producing a dry mixture according to one of claims 1 to 7, wherein
a) starch, biodegradable fibrous material and protein are mixed;
b) an aqueous solution is sprayed on during the mixing process; and
c) the mixture obtained in accordance with step b) is dried.

19. A process for producing a dry mixture according to one of claims 1 to 7, wherein
a) starch and biodegradable fibrous material are mixed;
b) an aqueous protein-containing solution is sprayed on during the mixing process; and
c) the mixture obtained in accordance with step b) is dried.

20. A process according to claim 18 or 19, wherein pregelatinised starch is also sprayed on in step b) during the mixing process.

21. A process according to one of claims 18 to 20, wherein mixing according to step b) and drying according to step c) are performed in a mutual step by fluidising in a fluidised bed in a warm stream of air.

22. A dry mixture according to one of claims 1 to 5, wherein the protein is plant protein.

23. A dry mixture according to claim 22, wherein the plant protein is soya protein.

24. A bakable material according to one of claims 8 to 12, wherein the protein is plant protein.

25. A bakable material according to claim 24, wherein the plant protein is soya protein.

26. A bakable material according to claim 25, wherein the bakable material contains soya protein in an amount of 0.5 to 10 wt. %, preferably 1 to 2 wt. %.

27. A bakable material according to one of claims 8 to 14 or 24 to 26, wherein the bakable material contains 0.05 to 0.7 wt. %, preferably 0.1 to 0.2 wt. % of mould release agent.

28. A bakable material according to claim 27, wherein the mould release agent is soya bean oil and/or palm fat.
